(19) United States
(12) Patent Application Publication
(10) Pub. No.: US 2015/0120513 A1
(43) Pub. Date: Apr. 30, 2015

(54) SYSTEM AND METHOD FOR TIRE INVENTORY CATALOGING AND MAINTENANCE

(71) Applicant: Maciej Wisniewski, West Bay (KY)

(72) Inventor: Maciej Wisniewski, West Bay (KY)

(21) Appl. No.: 14/067,944

(22) Filed: Oct. 30, 2013

(51) Int. Cl. G06Q 10/08

(52) U.S. Cl. CPC G06Q 10/087
USPC 705/28

(57) ABSTRACT

Disclosed is a method of cataloging tires into a tire inventory database comprising: acquiring a digital image of tread pattern on the selected tire using an imaging device; obtaining a tread depth measurement for the selected tire; recording size of the selected tire, brand of the selected tire, and model number of the selected tire; determining a selling price for the selected tire, and storing the digital image of tread pattern, the tread depth measurement, the size of the selected tire, the brand of the selected tire, the model number of the selected tire, and the selling price in a tire inventory database.

### CROSS REFERENCE TO RELATED APPLICATION

The present application is related to Utility patent application entitled “System and Method for Tire Inventory and Promotion,” filed 21 Nov. 2012 and assigned filing Ser. No. 13/683,908, incorporated herein by reference in its entirety.

### FIELD OF THE INVENTION

The present invention relates to a system and method for cataloging and maintaining an on-line tire inventory and, more particularly, to a web-based system for promoting sales of used tires.

### BACKGROUND OF THE INVENTION

Internal tire inventory systems comprising used tires have been known in the art for some years. However, such inventory systems are not typically available for searching by a nonemployee or a prospective tire customer and, more importantly, do not provide searchable parameters for the tires, such as one or more of: tread depth, tire make, tire model, tire price, seller stock number, tire location (or distance from the prospective tire customer), and image of tire tread. Moreover, conventional tire inventory systems tend to be too labor-intensive to be cost effective. What is needed is a system and method for maintaining an inventory of used tires, where a prospective customer can search the tire inventory using one or more of the above listed tire parameters.

### BRIEF SUMMARY OF THE INVENTION

In one aspect of the present invention, a method of cataloging a selected tire into a tire inventory database comprises: acquiring a digital image of tread pattern on the selected tire using an imaging device; obtaining a tread depth measurement for the selected tire; recording size of the selected tire, brand of the selected tire, and model number of the selected tire; determining a selling price for the selected tire, and storing the digital image of tread pattern, the tread depth measurement, the size of the selected tire, the brand of the selected tire, the model number of the selected tire, and the selling price in a tire inventory database.

In another aspect of the present invention, a method for cataloging and maintaining an on-line tire inventory database comprises: acquiring a digital image of tread pattern on a selected tire using an imaging device having speech recognition software and a capability for digital imaging; obtaining a tread depth measurement for the selected tire; creating an audio file using the imaging device, the audio file containing a recitation describing tire size of the selected tire, brand of the selected tire, and model number of the selected tire into one of the computing device and the mobile communication device; determining a selling price for the selected tire, and storing the digital image of tread pattern, the audio file, the tread depth measurement, and the selling price under a tire stock number in a tire inventory database.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical side view illustration of a tire inventory station, in accordance with the present invention;

FIG. 2 is a diagrammatical front view illustration of the tire inventory station of FIG. 1;

FIG. 3 is a flow diagram illustrating steps for entering tire data into a tire inventory database with a computing device or mobile communication device;

FIG. 4 is a diagrammatical illustration of a tire inventory cataloging and maintenance system accessed by the user of the tire inventory station of FIG. 1;

FIG. 5 is an example of a main menu page displayed in the computing or mobile communication device of FIG. 4;

FIG. 6 is a tire information collection page accessed from the inventory access page of FIG. 5;

FIG. 7 is a tire data page accessed from the tire information collection page of FIG. 6;

FIG. 8 is a tire data summary page accessed from the tire data page of FIG. 7;

FIG. 9 is flow diagram illustrating a prospective user setting up an account for listing tire data in the tire inventory cataloging and maintenance system of FIG. 4; and

FIG. 10 is an example of a profile page accessed by the prospective user in the process of setting up the account for listing tire data in the tire inventory cataloging and maintenance system of FIG. 4.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present invention relates generally to (i) a system and method for cataloging an inventory of new or used tires, and (ii) a method for maintaining the inventory of new or used tires. Fundamental to the operation of the disclosed method are resources for collecting tire information data, including: a device for measuring tire tread depth, an imaging device for acquiring digital images of tire tread patterns, and an inventory system that classifies tires according to brand, model, size, and tread depth.

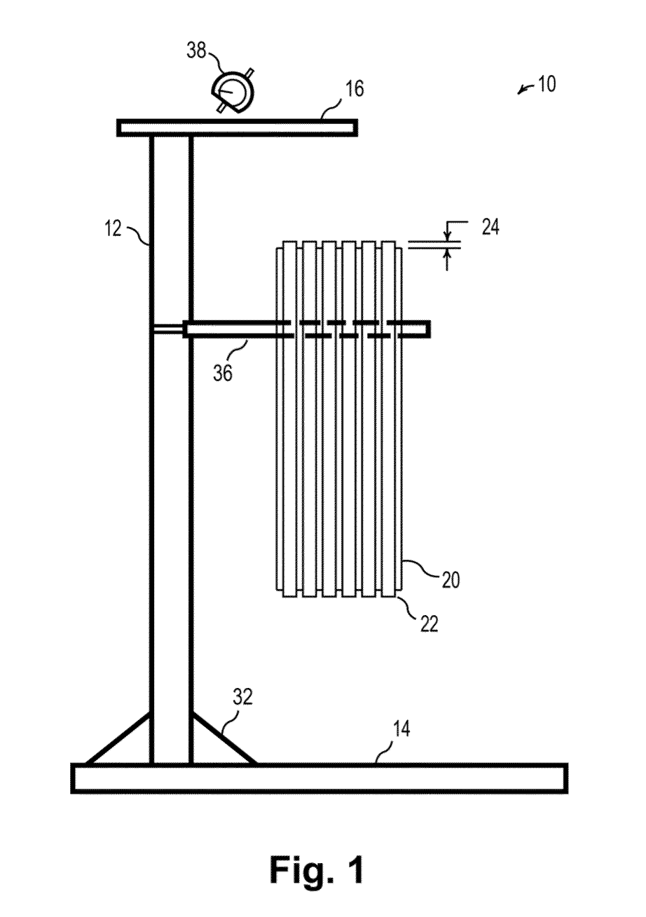

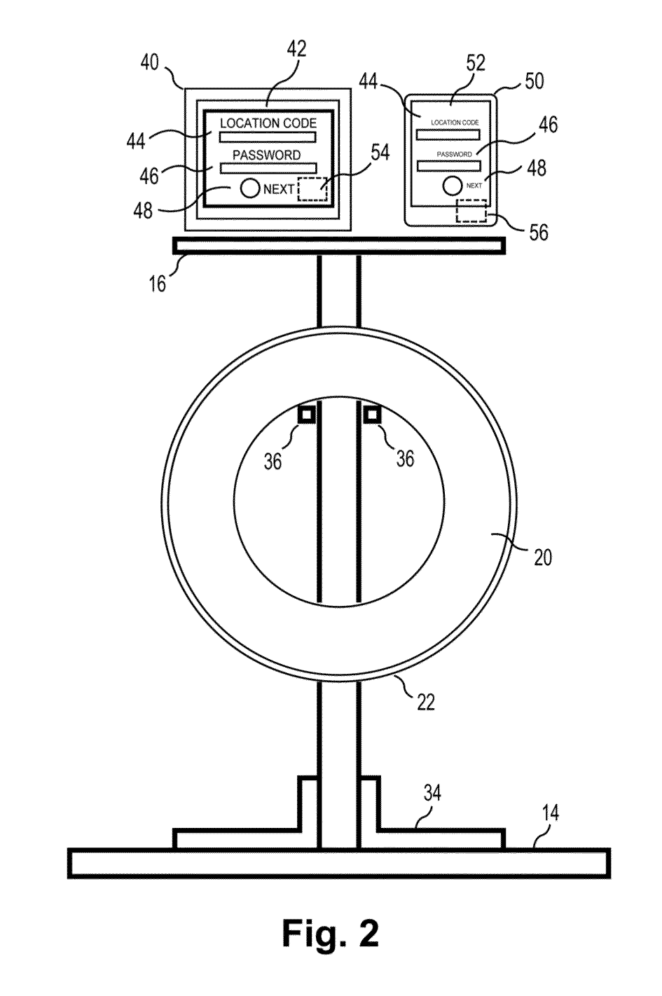

There is shown in FIGS. 1 and 2 a tire inventory station 10 that may be used to support a tire 20 in a tire inventory procedure, in accordance with an aspect of the present invention. In an alternative embodiment, the tire inventory procedure may be conducted without supporting the tire 20 in the tire inventory station 10 such as by placing the tire 20 on the ground, for example, or by accessing the tire 20 in a storage rack or on a shelf (not shown). The tire inventory station 10 may comprise a substantially vertical support beam 12 fixed to a base 14, and a work platform 16 secured to the vertical support beam 12. Gussets 32 or L-brackets 34 (shown in FIG. 2) may be provided to stabilize the support beam 12 on the base 14, as is known in the relevant art.

Tire support arms 36 may be slideably attached to the support beam 12 or alternatively, may be fixed to the support beam 12. The tire support arms 36 may each comprise a cantilever member of sufficient rigidity to support a conventional tire 20 (with or without rim or alloy wheel) above ground level, as shown in the diagram. In an exemplary embodiment, the location of the tire support arms 36 may be fixed at a specified distance from ground level, such as at waist level or at any height comfortable for a user (herein referred to as a “Tire Lister”). This configuration enables the Tire Lister to more easily image and measure tire tread depth 24, and to read the tire size on the tire sidewall, as described in greater detail below.

In an alternative work station configuration, the user may be able to loosen and reposition the tire support arms 36 so as to suspend the tire 20 at different desired working heights. The tire support arms 36 may be approximately twelve inches in length to provide support for the majority of tires that could be selected for listing in the tire inventory system. In an alternative embodiment, the fixed height and lengths of the tire support arms 36 may be different from the configuration described above, so as to accommodate alternate support requirements.

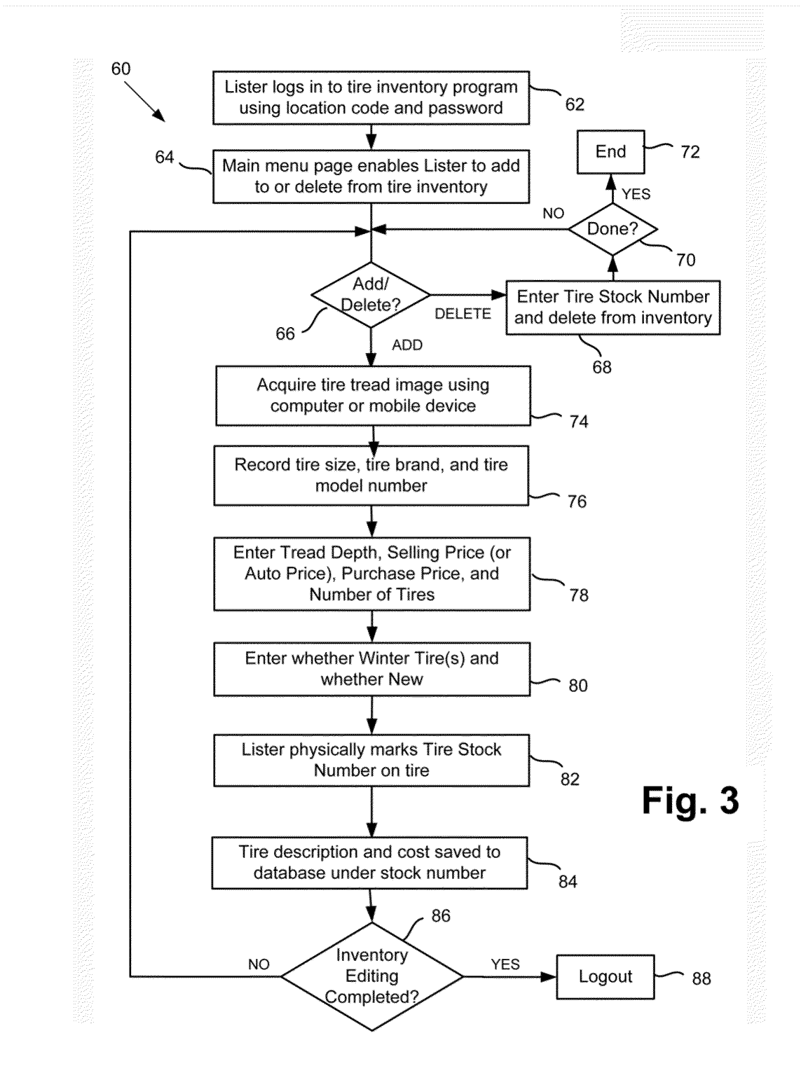

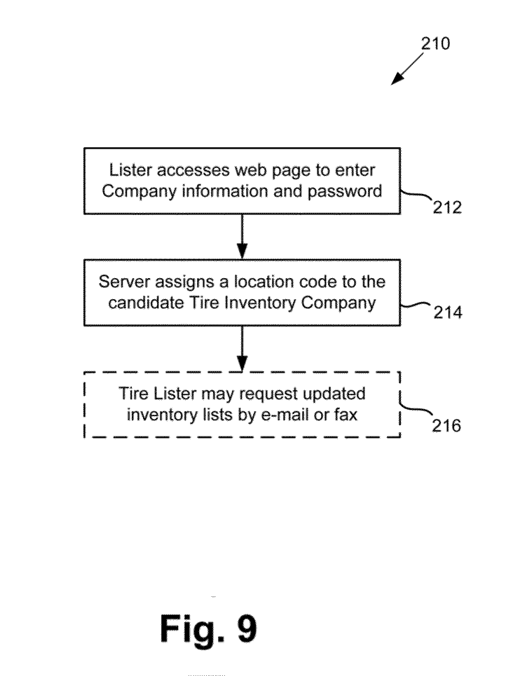

Performing a tire cataloging and maintenance procedure in accordance with the present invention may be explained with reference to a flow diagram 60, in FIG. 3. In the following example, it should be understood that the Tire Lister had previously subscribed to a tire inventory service (described below and illustrated in the flow diagram of FIG. 9) prior to beginning the process of accessing and maintaining a tire inventory. In an exemplary embodiment, when subscribing to the tire inventory service, the Tire Lister download a required software program or app from, for example: (i) a website maintained by the tire inventory service, (ii) a digital distribution platform such as Google Play, or (iii) a media library application such as iTunes.

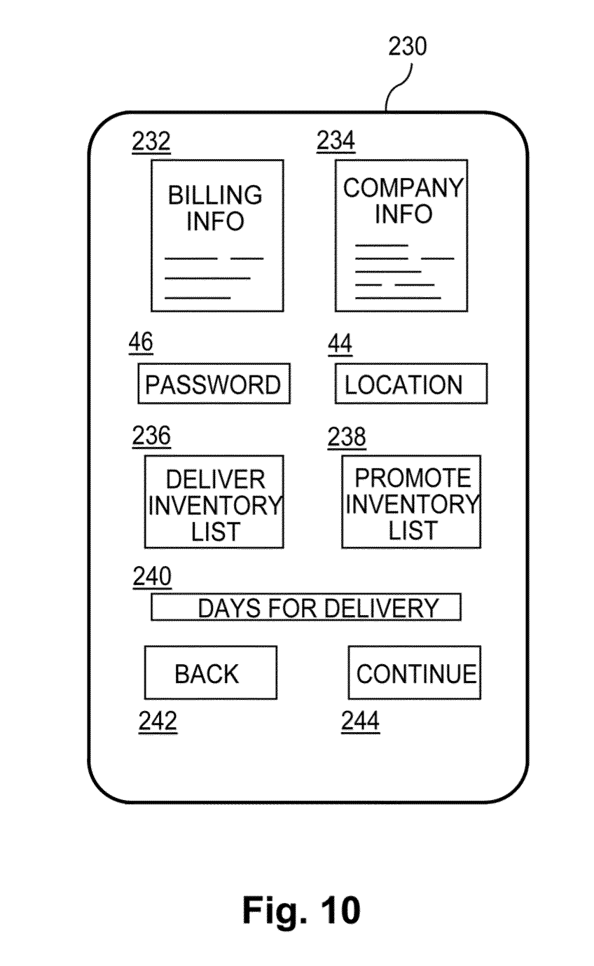

At step 62, the Tire Lister may enter a location code 44 and a password 46 in a tire inventory log-in page 42 in the computer tablet 40, or in a tire inventory log-in page 52 in the mobile communication device 50. The location code 44 was assigned to the tire inventory facility(ies) of the Tire Lister when subscribing to the tire inventory service, as shown in FIG. 10 below. The password 46 was selected by the Tire Lister when subscribing. By pressing a ‘next’ button 48, shown in FIG. 2, the Tire Lister accesses a tire inventory software program 54 resident in the computing device 40, or a similar tire inventory app 56 in the mobile communication device 50.

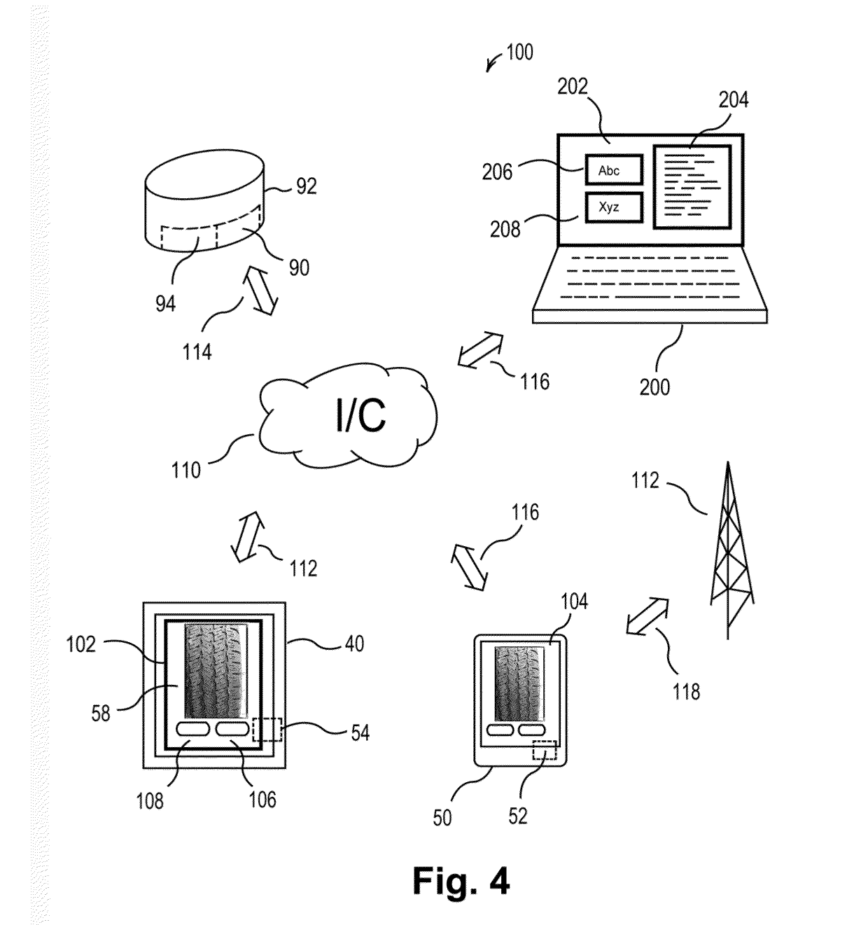

As shown in a tire inventory cataloging and maintenance system 100 of FIG. 4, the tire inventory software program 54 and the tire inventory app 56 enable the Tire Lister to communicate with a tire inventory cataloging and maintenance software application 90 resident in a remote server 92. The tire inventory cataloging and maintenance software application 90 manages an included tire inventory database 94 to support the methods and procedures described below.

As can be appreciated by one skilled in the art, the computer tablet 40 may access the tire inventory cataloging and maintenance software application 90 via a computer communication link 112, the Internet/Cloud 110, and a server communication link 114. Similarly, the mobile communication device 50 may access the tire inventory cataloging and maintenance software application 90 via a mobile device communication link 116, the Internet/Cloud 110, and the server communication link 114. Alternatively, the mobile communication device 50 may access the tire inventory cataloging and maintenance software application 90 via a cellular link 118 to a cell tower 122 for connection to the server communication link 114 via the Internet/Cloud 110.

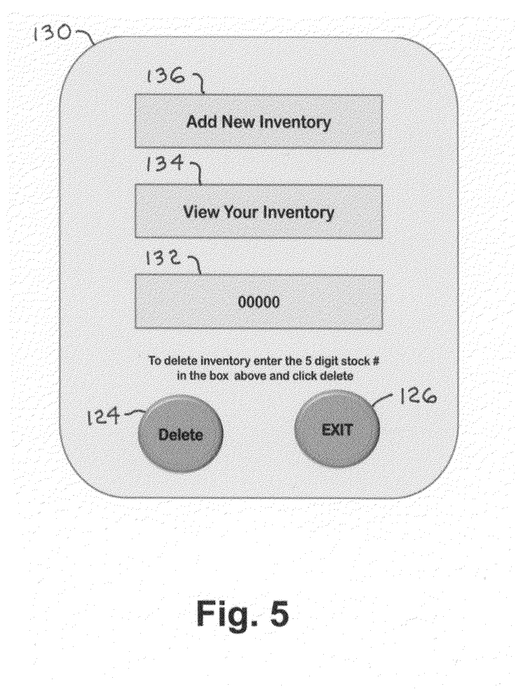

After the Tire Lister has entered the location code 44 and the password 46 into the start page, the tire inventory cataloging and maintenance software application 90 may bring up a web page denoted herein as a main menu page 130, shown in FIG. 5, at step 64. The main menu page 130 includes an ‘add new inventory’ box 136 and a ‘view your inventory’ box 134.

The main menu web page 130 includes a ‘delete’ button 124 for removing tire stock from inventory after the Tire Lister has entered the stock or catalog number of the tire to be deleted. The Tire Lister may access the tire inventory database 94 by using the ‘view your inventory’ box 134 to find the stock number of a tire, for example. The view your inventory box 134 may be viewed on the computer tablet 40 or on the mobile communication device 50 as desired.

If, at decision block 66, the Tire Lister chooses to delete a tire that has been removed from stock, or is to be removed from stock, the catalog or stock number of the removed tire may be entered into a ‘tire stock number’ box 132, and the delete button 124 may be selected or activated, at step 68. If the Tire Lister has completed his tire inventory updating, at decision block 70, an exit button 126 may be selected to end the tire inventory software program 54 or the tire inventory app 56, at step 72. If the Tire Lister intends to continue tire inventory updating and cataloging, at decision block 70, the process returns to decision block 66.

If the Tire Lister wishes to add new inventory, such as a selected tire, at decision block 66, the Tire Lister selects the add new inventory box 136 to bring up a tread imaging page 102 in the display of the computer tablet 40, or a tread imaging page 104 in the display of the mobile communication device 50. This action automatically activates an imaging or camera system in the computing device 40 or in the mobile communication device 50. It should be understood that the process of imaging the tire tread can be done by various types of imaging devices, and practicing the disclosed invention is not limited to the use of a computing device, a computer tablet, a mobile communication device, a personal digital assistant, or a video camera. Preferably, the imaging device used to image the tire tread includes speech recognition software in addition to having a capability for digital imaging.

The Tire Lister may, at this point, manually measure the tire tread depth 24 of the selected tire with a tire tread depth gauge 38. The tread depth reading so obtained may be entered into the tire inventory database 94 using the computer tablet 40, the mobile communication device 50, or any similar computing and storage device that provides a touchscreen, or responds to vocal instructions, for performing data entry and that has digital imaging capabilities.

In an exemplary embodiment, the computer tablet 40 and the mobile communication device 50 may each function as a digital imaging camera to allow capture and storage of digital images of the tire tread 22, in addition to enabling data entry for cataloging. For physical inventory purposes, the tire 20 may also be marked by a grease pencil or other marking device, or may be identified with a self-adhering label (not shown), as preferred by the Tire Lister.

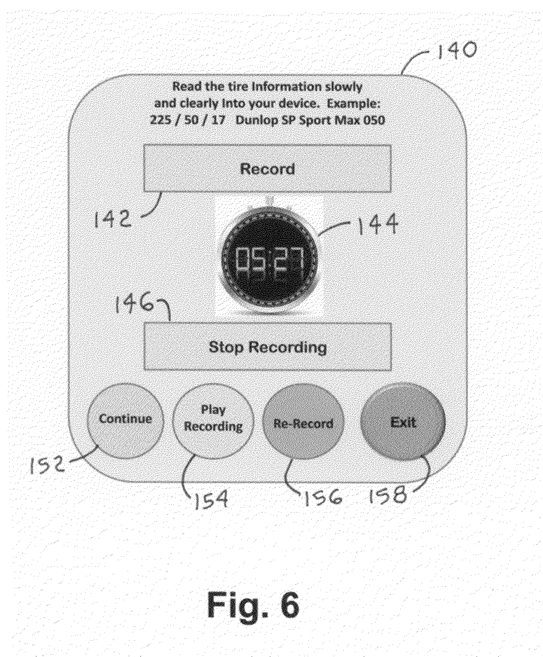

The Tire Lister may then acquire a tire tread image 58 on a display screen of the imaging device, and may select a ‘use’ or ‘capture’ button 106, at step 74, if the acquired tire tread image 58 is acceptable. However, if the acquired image does not meet the standards of the Tire Lister, the tire tread image 58 may be reimaged using a ‘retake’ or ‘cancel’ button 108. After the tire tread image 58 has been accepted, the tire inventory cataloging and maintenance software application 90 brings up a tire information collection page 140, shown in FIG. 6.

The tire information collection page 140 is provided to enable the Tire Lister to enter required tire information verbally. The tire information page 140 may include a ‘record’ box 142, an elapsed-time indicator 144, and a ‘stop recording’ box 146. Upon selecting the record box 142, the Tire Lister may read the tire size, the tire brand, and the tire model for the selected tire into the computer tablet 40 or into the mobile communication device 50, at step 76. The Tire Lister can next press: (i) a ‘continue’ button 152 to continue to another page; (ii) a ‘play’ button 154 to play back the tire information just recorded; (iii) a ‘re-record’ button 156 to again record the tire information; or (iv) an ‘exit’ button 158 to terminate the tire inventory software program 54 or the tire inventory app 56.

Preferably, the computer tablet 40 and the mobile communication device 50 include speech recognition software, whereby the Tire Lister can enter the required tire data (i.e., tire size, brand, and model) by verbally reciting the tire size, brand, and model to either the computing device 40 or to the mobile communication device 50. An audio file thus generated by the Tire Lister, will contain a recitation of a description of the tire size, brand, and model for the selected tire, and may be stored in the remote server 92 for playback by a potential tire customer. In an alternative embodiment, the Tire Lister may verbally recite one or more of: (i) the tread depth, (ii) the tire selling price, (iii) whether the tire is new, (iv) whether the tire is a winter tire, and (v) number of tires into the audio file, in addition to the tire size, brand, and model.

In an exemplary embodiment, the data provided by the audio file may be played back by a tire inventory associate and transcribed into a format suitable for storage in the remote server 92. In an alternative embodiment, speech recognition software in the computing device 40, in the mobile communication device 50, or in the tire inventory cataloging and maintenance software application 90 may also function to convert the audio file into digital data form.

It can be appreciated that the tire inventory cataloging and maintenance software application 90 may further function to convert the tire data entered on the tire information page 140 into search terms for use by a potential customer looking for a tire of a particular size, brand, and/or model number. The search terms may thus be obtained from: (i) the data entered by the tire inventory associate, or (ii) directly from the tire data entered verbally by the Tire Lister and converted by the voice recognition software into searchable data.

The tire inventory cataloging and maintenance software application 90 may send confirmation to the Tire Lister of the addition of one or more tires to inventory by, for example, transmitting a copy of the updated inventory organized by tire size, tire model, tire brand, tire tread depth, and tire price. The confirmation action may be executed by: (i) sending a facsimile confirmation to a fax machine (not shown) accessible by the Tire Lister, (ii) sending an e-mail confirmation to the computer tablet 40 or to the mobile communication device 50, or (iii) sending both the fax confirmation and the e-mail confirmation to the Tire Lister.

The confirmation transmittal may be executed on a date and time specified by the Tire Lister, or as generated by the tire inventory cataloging and maintenance software application 90. The Tire Lister may thus have access to a specified tire inventory online, and may be able to search the tire inventory database 94 using one or more tire data parameters including, for example: tire size, tire brand, tire model, and tire stock number.

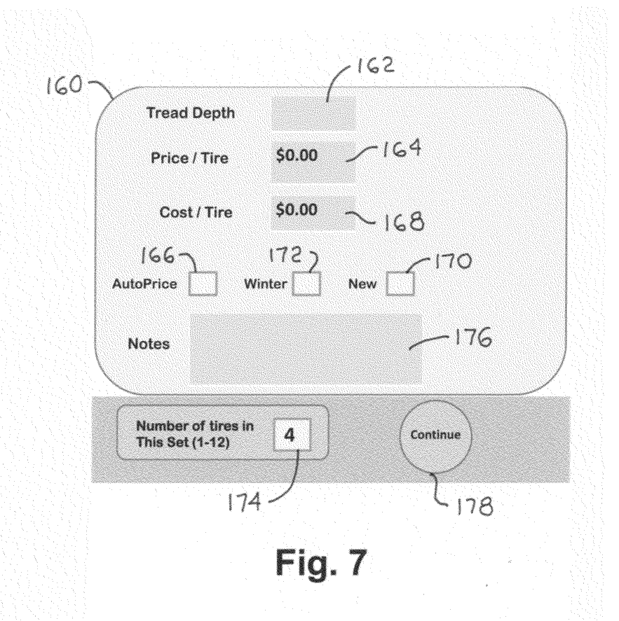

Selecting the continue button 152 in the tire information collection page 140 brings the Tire Lister to a tire data access page 160, shown in FIG. 7. The measured tread depth can be entered in a ‘tread depth’ box 162, in step 78. The Tire Lister can enter a selling price for the current tire in a ‘price/tire’ box 164. Alternatively, the Tire Lister can check off an ‘autoprice’ box 166 and allow the tire inventory cataloging and maintenance software application 90 to automatically enter a suggested or market value for the tire, rather than expecting data entry from the Tire Lister. The original purchase price of the tire may be entered in a ‘cost/tire’ box 168, if desired. Preferably, the original purchase price is not viewable by a prospective tire customer.

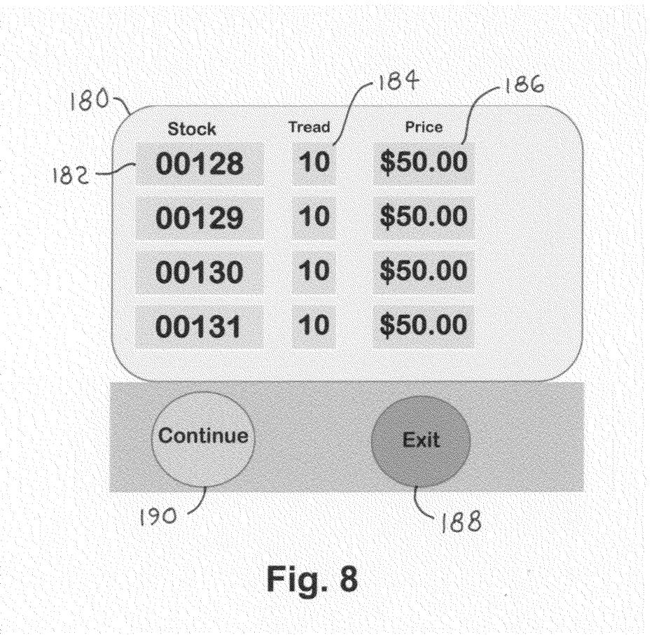

If the tire is new, the Tire Lister may check a ‘new’ box 170 and, if the tire is a winter tire, the Tire Lister may check off a ‘winter’ box 172, at step 80. The total number of same tires being added to the tire inventory is entered into a ‘number of tires’ box 174. If the Tire Lister wishes to include any additional information, text can be entered into a ‘notes’ box 176. If more than one tire is being added to inventory, a tire tread image 58 of each tire may be obtained and entered into the tire inventory database 94, if the Tire Lister needs to show similarity or differences among the treads of the tires being added to inventory. By pressing a ‘continue’ button 178, the Tire Lister may proceed to a tire data summary page 180, shown in FIG. 8.

The tire data summary page 180 presents in summary form the tire cataloging information that is to be added to the tire inventory. The tire stock number assigned to each current tire is shown in a column of ‘stock number’ boxes 182. The measured tread depth entered for each tire is shown in a column of ‘tread’ boxes 184, and the corresponding selling price is shown in a column of ‘price’ boxes 186. If desired, the Tire Lister can still make changes to the data in the tread box 184 and in the price box 186.

At this point, the Tire Lister can physically mark a corresponding tire with the catalog or stock number provided in the stock box 182, at step 82. Once the Tire Lister has validated the tire information and continues cataloging, the tire inventory cataloging and maintenance software application 90 may send the tire description, cost, tire tread image(s) 58, and stock number(s) to the tire inventory database 94, at step 84. Accordingly, tire information, such as tire size, tire brand and tire model number may be saved in the tire inventory database under the stock number.

The procedure for assigning the computer-assigned stock numbers 182 may be illustrated by the following example. There may be one hundred tires in stock, assigned respective tire stock numbers 0001 through 0100, for example. If tire stock numbers 0045 and 0060 are sold, for example, and removed from inventory, the next time new inventory is added, using the tire inventory software program 54 or the tire inventory app 56, the tire inventory cataloging and maintenance software application 90 may assign the available tire stock numbers 0045 and 0060 to the next two tire entries. This procedure allows the Tire Lister to numerically organize the tire inventory such that, when a particular tire is sought, the Tire Lister will have a tire catalog or stock number with which to conduct a search.

If, at decision block 86, the Tire Lister has completed tire inventory cataloging and maintenance, an ‘exit’ button 188 may be pressed to log out of the tire inventory cataloging and maintenance software application 90, at step 88. If, at decision block 86, the Tire Lister plans to add to or delete additional tire stock, the process returns to decision block 66, as described above.

In an exemplary embodiment, a potential tire customer may be able to independently search the tire inventory database 94 by accessing a tire inventory website 202 using a customer communication device, such as a smart phone, a computer tablet, or a laptop 200 as shown in FIG. 4. As can be appreciated by one skilled in the art, the tire inventory website 202 can be promoted through various methods of advertising, and by use of social media.

The tire customer may search for specific tires by entering values for one or more of the following tire cataloging parameters: (i) tire size, (ii) tire brand, (iii) tire model, (iv) tire tread depth, and (v) tire location proximity. The tire inventory website 202 may display a tire list 204 generated by the tire inventory cataloging and maintenance software application 90 in response to the one or more values for search parameters 206, 208 entered by the customer.

When the customer selects an entry in the tire list 204 by highlighting and clicking the tire inventory website 202 display, there may be provided a more detailed record of the selected entry such as, for example, an image of the actual tire tread, whether the tire includes a tire rim, an audio file of the Tire Lister describing the tire in the selected entry, and the contact information of the tire seller. Accordingly, the tire customer may wish to contact the tire seller directly and complete the sale in person or by telephone.

A prospective Tire Lister may sign up a candidate tire inventory company for subscribing to the above-described tire inventory service, and for access to the tire inventory cataloging and maintenance software application 90. This may be accomplished by following a procedure such as that described in a flow diagram 210, in FIG. 9. To subscribe, the Tire Lister may access an on-line profile page 230, enter billing information 232, enter company information 234, and select the password 46, at step 212. The remote server 92 may assign the location code 44 to the newly-subscribing tire inventory company, at step 214, based on the physical location(s) of the tire inventory maintained by the prospective Tire Lister.

If the Tire Lister keeps tire stock at more than one location, the Tire Lister can select an affiliate code, which may be four digits for example, and the affiliate code may be assigned to all the tire stock locations managed by the Tire Lister. Accordingly, the affiliate code may be entered into a ‘store name’ field (not shown) that may be provided as an option in the tire inventory login page 42, 52, or that may be provided in a web page, such as may be found at a URL related to a site denoted by, for example, ‘findthetires.com.’ By entering an affiliate code, the Tire Lister may be enabled to conduct a search accessing inventories in all tire stock locations owned by the Tire Lister.

At step 216, the Tire Lister may also choose whether to receive updated inventory lists 236, by e-mail or by facsimile for example, and whether to have the company tire inventory list promoted 238 by the tire inventory cataloging and maintenance software application 90. The Tire Lister may specify the days for delivery of the updated inventory lists in a “Days for Delivery” window 240. A ‘back’ button 242 and a ‘continue’ button 244 may be provided to allow the Tire Lister to navigate between web pages.

After the location code 44 has been assigned to the Tire Lister by the tire inventory cataloging and maintenance software application 90 for the address or physical location of the candidate tire inventory company, the prospective Tire Lister may then be given access to the inventory access page 130, where the Tire Lister can begin entering tire inventory data, as described above.

It is to be understood that the description herein is exemplary of the invention only and is intended to provide an overview for the understanding of the nature and character of the disclosed tire inventory cataloging and maintenance system. The accompanying drawings are included to provide a further understanding of various features and embodiments of the method and devices of the invention which, together with their description serve to explain the principles and operation of the invention.

What is claimed is:

1. A method of cataloging a selected tire into a tire inventory database, said method comprising the steps of:
acquiring a digital image of tread pattern on the selected tire using an imaging device;
obtaining a tread depth measurement for the selected tire;
recording size of the selected tire, brand of the selected tire, and model number of the selected tire;
determining a selling price for the selected tire, and
storing said digital image of tread pattern, said tread depth measurement, said size of the selected tire, said brand of the selected tire, said model number of the selected tire, and said selling price in a tire inventory database.

2. The method of cataloging a selected tire of claim 1 wherein said imaging device comprises one of a computing device and a mobile communication device.

3. The method of cataloging a selected tire of claim 1 wherein said step of recording comprises the steps of verbally reciting said size of the selected tire, said brand of the selected tire, and said model number of the selected tire into one of said computing device and said mobile communication device.

4. The method of cataloging a selected tire of claim 1 wherein said imaging device comprises speech recognition software.

5. The method of cataloging a selected tire of claim 1 further comprising the step of determining whether the selected tire is a new tire and determining whether the selected tire is a winter tire.

6. The method of cataloging a selected tire of claim 1 wherein said step of determining said selling price is automatically performed by software managing said tire inventory database.

7. The method of cataloging a selected tire of claim 1 wherein a stock number is automatically assigned to the selected tire by software managing said tire inventory database.

8. The method of cataloging a selected tire of claim 7 wherein said stock number is physically marked on the selected tire.

9. The method of cataloging a selected tire of claim 7 wherein said size of the selected tire, said brand of the selected tire, and said model number of the selected tire are saved in said tire inventory database under said stock number.

10. A method of method for cataloging and maintaining an on-line tire inventory database, said method comprising the steps of:
acquiring a digital image of tread pattern on a selected tire using an imaging device having speech recognition software and a capability for digital imaging;
obtaining a tread depth measurement for said selected tire;
creating an audio file using said imaging device, said audio file containing a recitation describing tire size of said selected tire, brand of said selected tire, and model number of said selected tire into one of said computing device and said mobile communication device;
determining a selling price for said selected tire, and
storing said digital image of tread pattern, said audio file, said tread depth measurement, and said selling price under a tire stock number in a tire inventory database.

11. The method for cataloging and maintaining an on-line tire inventory database of claim 10 further comprising the step of saving said size of the selected tire, said brand of the selected tire, and said model number of the selected tire in a tire inventory database under said stock number.

12. The method for cataloging and maintaining an on-line tire inventory database of claim 10 further comprising the step of deleting said selected tire from said tire inventory database by entering a tire stock number into a main menu web page and activating a delete button.

13. The method for cataloging and maintaining an on-line tire inventory database of claim 10 wherein said audio file further comprises a recitation describing one or more of tread depth for said selected tire, selling price for said selected tire, whether said selected tire is new, and whether said selected tire is a winter tire.

14. The method for cataloging and maintaining an on-line tire inventory database of claim 10 wherein a prospective tire purchaser accesses said tire inventory database and conducts an on-line search for a tire using, as search terms, cataloging parameters including one or more of tire size, tire brand, tire model number, tire tread depth, and tire location proximity.

15. The method for cataloging and maintaining an on-line tire inventory database of claim 14 wherein said prospective tire purchaser retrieves, via said on-line search, a tire tread image and an audio file, said audio file describing a tire having said tire tread in said tire tread image.
